(19) United States
(12) Patent Application Publication
(10) Pub. No.: US 2014/0284224 A1
(43) Pub. Date: Sep. 25, 2014

(54) TANK FOR STORING AMMONIA BY SORPTION

(71) Applicant: INERGY AUTOMOTIVE SYSTEMS RESEARCH (Societe Anonyme), Bruxelles (BE)

(72) Inventors: Francois Dougnier, Boortmeerbeek (BE); Jules-Joseph Van Schaftingen, Wavre (BE); Pierre De Keyzer, Brussels (BE)

(73) Assignee: INERGY AUTOMOTIVE SYSTEMS RESEARCH (Societe Anonyme), Bruxelles (BE)

(21) Appl. No.: 14/348,420

(22) PCT Filed: Oct. 1, 2012
(86) PCT No.: PCT/EP2012/069342

§ 371 Date: Mar. 28, 2014

(30) Foreign Application Priority Data
Sep. 30, 2011 (EP) 11183413.1

(51) Int. Cl. F17C 11/00

(52) U.S. Cl. CPC F17C 11/00
USPC 206/7

(57) ABSTRACT

A tank for storing ammonia by sorption, the tank including cells, or cells made of plastic, that communicate with one another and with at least one orifice that communicates with the outside, the cells configured to contain a solid intended for the sorption of ammonia.

The invention relates to a tank for storing ammonia by sorption, preferably by chemisorption on a solid.

The nitrogen oxides present in the exhaust gases of vehicles, notably diesel, can be eliminated by the selective catalytic reduction technique (generally called SCR). In this method, doses of ammonia are injected into the exhaust line upstream of a catalyst on which the reduction reactions take place. Currently, the ammonia is produced by thermal decomposition of a precursor, generally an aqueous solution of urea. On board systems for storing, distributing and dosing a normalized urea solution (such as that marketed under the trade name Adblue®, 32.5% eutectic solution of urea in water) have thus been placed on the market.

Another technology consists in storing the ammonia by sorption on a salt, more often an alkaline earth metal chloride. The thermal activation then makes it possible to restore the ammonia in the vehicle operating phase. A pressure of ammonia is therefore generated. Thus, it seems necessary to have a system whose function is to fulfill the various functionalities associated with this technology in the case of an application to vehicles. The current systems, in the prototype state, use a cylindrical stainless steel storage tank, with peripheral heating.

The American patent application U.S. 2010/0062296 proposes a system for storing ammonia by chemisorption involving at least two tanks or compartments of one and the same tank containing different absorbent materials and having different sizes, these tanks/compartments communicating to allow for the passage of ammonia between them. Once the system has used up the ammonia, the larger of them (generally the one which serves as a reserve for the smaller one) is replaced.

The present invention aims to provide a tank for storing ammonia by sorption, which is easy to manufacture, whose form can easily be adapted to its environment on a vehicle and which can easily be topped up with ammonia instead of being at least partially replaced.

To this end, the invention relates to a tank for storing ammonia by sorption, said tank comprising cells communicating with one another and with at least one orifice communicating with the outside, these cells being suitable for containing a solid intended for the sorption of ammonia.

“Tank” should be understood to mean a vessel or enclosure delimiting at least one internal volume serving as a container for the solid. According to the invention, the tank comprises at least one wall delimiting cells, that is to say cavities, likely to contain said solid. These cavities can have any form. Preferably, they all have the same form.

According to the invention, the solid is intended for the sorption (preferably, for the chemisorption) of ammonia. The abovementioned American patent application describes and lists such solids, and its content is, to this end, incorporated in the present application. They are generally chlorides of alkali, alkaline earth or transition metals. These solids can be in the powder state or in the form of agglomerates. Preferably, there is one agglomerate per cell. The form and the size of the cells are preferably adapted to be able to closely follow at least a part of the outer surface of the agglomerates.

Preferably, the cells are made of plastic, notably from the category of thermoplastics. The thermoplastic materials give good results in the context of the invention, notably because of the advantages of weight, of mechanical and chemical strength and of ease of implementation (which is precisely what makes it possible to obtain complex forms).

In particular, it is possible to use polyolefins, polyhalogenates of vinyl, thermoplastic polymers, polyketones, polyamides, polyphthalamides and their copolymers. A mixture of polymers or of copolymers can also be used, as can a mixture of polymeric materials with inorganic, organic and/or natural fillers such as, for example, but in a nonlimiting manner: carbon, salts and other inorganic derivatives, natural fibers, glass fibers and polymeric fibers. It is also possible to use multilayer structures made up of stacked and securely attached layers comprising at least one of the polymers or copolymers described above.

Excellent results have been obtained with polyphthalamide filled with glass fibers.

In one embodiment, at least two cells are offset by an angle (a).

Such a configuration allows for an arrangement of the cells that adapts to the form of the tank when the latter is of complex form, notably if it comprises curved portions.

The cells of the tank according to the invention can at least partly be made of a single piece, for example in the form of injection-molded plates. Preferably, a bottom plate comprising sinusoidal segments is assembled with a dome-shaped top plate.

Lateral reinforcements in the form of ribs can be added in order to enhance the mechanical strength of the cells.

Alternatively, the cells can be produced separately (individually or in groups), for example by plastic injection or blow molding, then assembled by any known means, such as by welding for example. This variant makes it possible to produce a non-parallel assembly of the cells, that is to say such that, with cells of identical form, at least one of the faces of said cells is not parallel to the like face of its neighbor.

The production of groups of cells by injection is particularly advantageous because it notably makes it possible to produce very small cells economically. Now, the cells of small size are advantageous because they exhibit a good resistance to internal pressure (or depressurization), and make it possible to improve the heat exchange between the heating and/or cooling systems and the reagent, notably by virtue of a lesser thermal inertia. Furthermore, cells of small sizes provide improved operating safety. In practice, if the operation of one of the cells becomes defective, said defective cell has a correspondingly lesser effect on the overall operation of the tank when its size, and therefore the quantity of reagent that it contains, is limited. In particular, if the defective operation results in an undesirable discharge of ammonia, the quantity discharged will be that much lower when the size of the cells is small. Furthermore, the lesser thermal inertia of the cells of small sizes allows for a faster cooling if the heating is interrupted. This faster cooling leads to a reduction of the internal pressure of the cells that is also faster, which also increases the safety of the tank when the heating is stopped in the event of malfunction.

The diameter of the cells (for the case where they have a substantially circular cross section and, in the contrary case, the diameter of a cylinder in which a cell can be inscribed), will, for example, be between 15 and 100 mm, preferably between 40 and 80 mm.

According to the invention, the cells communicate with one another so as to ensure the circulation of ammonia both during filling (topping up) of the tank and during its use (ammonia consumption or discharge). This communication is generally provided by at least one orifice in each cell and by a device linking these orifices together and to at least one orifice communicating with the outside of the tank, so as to allow for its ammonia to be topped up and discharged.

In a variant, all of the cells, or a subgroup thereof, are topped by a network of passages ensuring communication between them. This variant is particularly advantageous in the case where the cells are produced from at least one sheet/plate locally welded to form the cells. In this variant, said network also generally provides a role of mechanical reinforcement, increasing the mechanical strength and the resistance to pressure or to depressurization of the tank. In this variant, the network can be free but, preferably, it is securely attached to a cover covering the cells and acting as an additional reinforcement.

In another variant, which can optionally be combined with the preceding variant, the cells are grouped together under a common cover, delimiting, with their top face, a hollow volume, and each cell comprises at least one orifice communicating with this volume, the cover comprising at least one orifice ensuring communication between this volume and the outside of the tank. In this variant, the cover can also serve to join the cells together (make them mechanically securely attached) and/or to reinforce the tank.

In one embodiment, the cover also comprises said network of passages.

In one embodiment, the tank comprises at least one other network of passages, said network of passages and said at least one other network of passages being arranged in such a way as to form a reinforcing jacket.

Preferably, the form of the cells (all or some thereof) and/or their production and/or assembly method is such that at least one active element of the system (fulfilling a useful function such as heating, cooling, mechanical reinforcement, temperature probe, etc.) can be inserted into or between them.

In one embodiment, some cells are provided with one or more channels forming at least one housing making it possible to house at least one active element of the system.

In one embodiment, said at least one housing is situated between the cells and outside the internal volume thereof.

In one embodiment, said at least one active element is housed removably in said at least one housing.

For example, a heating element or a material with change of phase (MCP, or material storing or restoring heat by changing phase according to the temperature around it) is advantageously inserted into or between the cells.

The use of heating elements or of materials with change of phase makes it possible to stabilize the temperature of the reagent contained in the cell and thus ensure a stable production of ammonia. Furthermore, the use of differentiated heating between cells and/or of different relative quantities of materials with change of phase between cells makes it possible to deplete or enrich the ammonia content of certain cells; for example, when the system is stopped (for example following a stopping of the vehicle), the ammonia charge in the cells cooling more quickly (containing for example little or no material with change of phase) will increase to the detriment of the cells cooling more slowly (for example containing a lot of material with change of phase). This can be particularly advantageous for ensuring a rapid provision of ammonia after a stopping of the vehicle, for example by, at this moment, preferentially activating the ammonia-rich cells.

The cells can also be passed through or penetrated, preferably in their greater dimension, by one or more channels, possibly blocked at one of their ends and which also allows for the insertion of an active element of the system. This arrangement is particularly favorable for the positioning of heating or cooling means: the channels being placed substantially at the center of the reagent allow for rapid heat exchanges. Furthermore, if the internal housing of the channels is separated from the reagents by the wall (in other words: if the channels are separated in a seal-tight manner from the internal volume of the cells), the heating or cooling means which are positioned therein do not have to be attached in a seal-tight manner. This in particular makes it possible to dismantle them easily, and alternatively to mount heating means (for the desorption of this ammonia) or cooling means (for the absorption of ammonia) in these channels.

Good results have been obtained when the number of channels on all the cells is greater than 1 channel for every 4 liters of reagent; this is particularly the case when this number exceeds 1 per liter of reagent.

The heating means and/or MCP, as well as the cooling means, can be placed both in internal channels and outside the cells, even, with regard to the MCPs, inside the cells, in the chamber of the reagent. A particularly advantageous combination is to place the heating means in channels as described previously and the MCPs outside the cells, possibly topped by insulation means; this configuration in fact makes it possible to obtain good dynamic performance levels from the heating system: in the event of startup in cold conditions, the heat generated inside the channels is in fact very rapidly transmitted to the reagent, because the enthalpy necessary to heat the channels is low given their small dimensions and their low weights. The MCPs placed outside the cells start to heat up only after the bed of reagent is heated and make it possible to recover the heat arriving at the periphery and to stabilize the temperature of the reagents and the pressure of ammonia. The MCPs placed outside also provide an insulating effect, complementing that provided by the insulators which can be placed in an outer layer above the MCPs.

In a particularly advantageous variant of the invention, the tank comprises an MCP in at least some of the cells and/or between at least some thereof and/or in a channel insulating at least some thereof.

The walls of the cells can be provided with internal ribs allowing for the correct passage of the gases between the reagents and the walls. This passage also makes it possible to limit the heat losses to the outside of the device.

In a variant of the invention, the tank has at least one inlet allowing it to be filled with ammonia, from a carboy for example. It can also have an outlet, allowing for filling by scavenging with ammonia, possibly diluted. If necessary, the tank can be drained of the ammonia by drawing in a vacuum, or under the effect of a gaseous flow.

The present invention also relates to a tank as described above and containing the solid as described above. It also relates to such a tank also comprising at least one active element as described above.

Finally, the present invention relates also to a method for storing ammonia using a tank as described above.

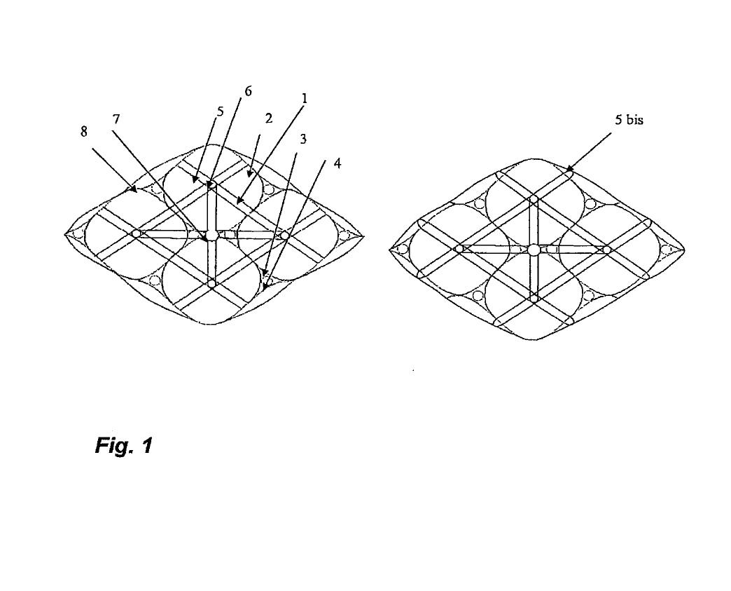

The invention is illustrated in a nonlimiting manner by the attached FIGS. 1 to 3, which illustrate thereof, schematically:

FIG. 1: a plan view of a tank according to a first variant of the invention;

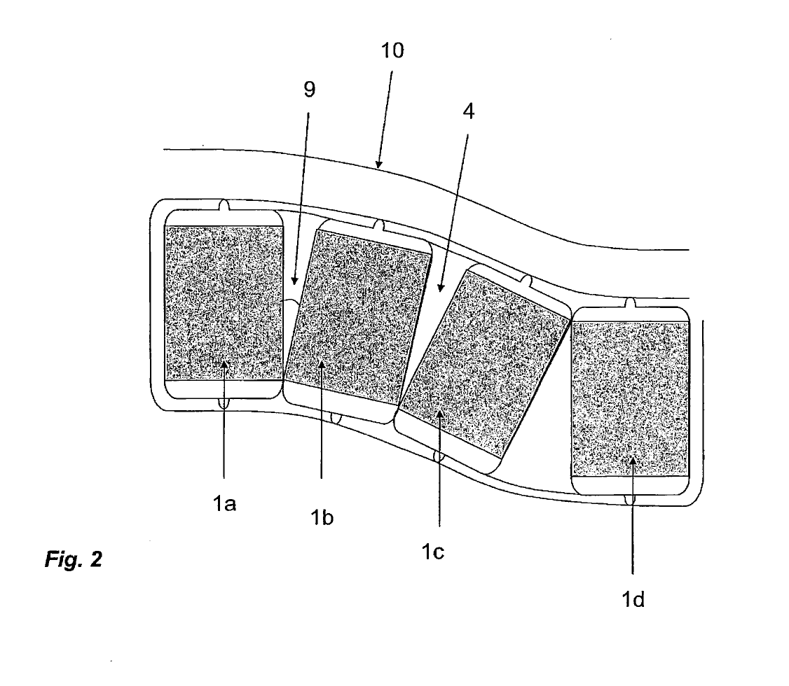

FIG. 2: a cross-sectional view through a vertical plane of a tank according to a second variant of the invention;

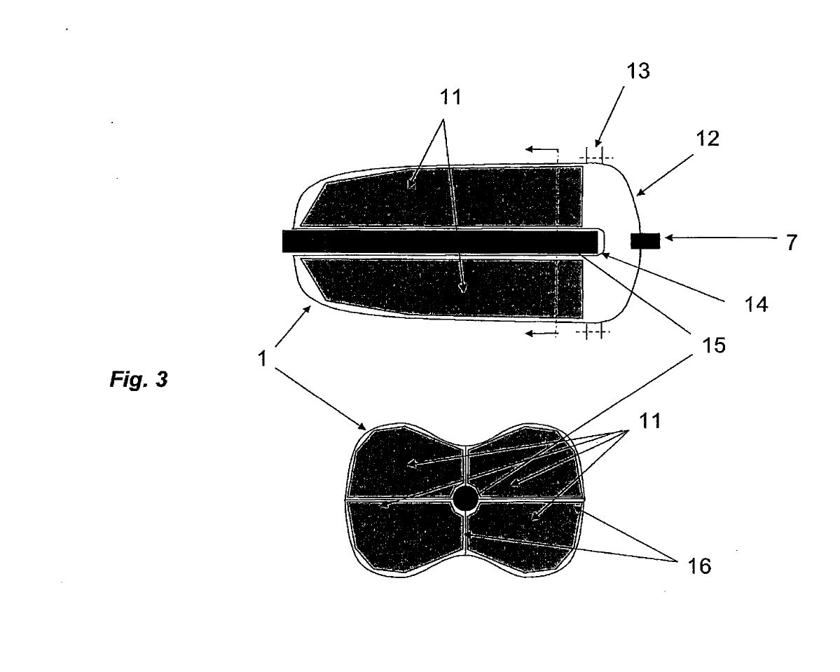

FIG. 3: two cross-sectional views along vertical planes at right angles to one another, of a tank according to a third variant of the invention.

In these figures, identical reference numbers designate identical or similar elements.

FIG. 1 illustrates a tank partitioned into cells (1) of identical sections. The cells are dimensioned in such a way that reagents (not represented) can be inserted therein. The walls (2) of the cells are profiled so as to exhibit a good resistance to the generation of pressure and to the creation of a vacuum. In the example represented, the walls are made up of sinusoidal segments. The interstices (3) between the cells have voids (4) which communicate with the outside environment and are exploited for the insertion of heating or cooling elements. They form a heat exchange network.

A dome-shaped cover (not represented) is fastened on top of the cells; it comprises a network of passages (5) which reinforce the structure of the whole. These passages communicate with the interior of the cells through orifices (6). The cover is assembled in a totally seal-tight manner on the outer periphery of the tank. The assembly between the cover and the walls of the cells internal to the tank can be done in a partially or totally seal-tight manner.

The cover has at least one inlet (7) allowing for the filling with ammonia, from a carboy for example.

In a variant of this example, the tank can have an outlet, allowing for filling by scavenging with ammonia, possibly diluted. If necessary, the tank can be drained of the ammonia by drawing in a vacuum, or under the effect of a gaseous flow.

Secondary chambers (8), arranged laterally in this example, make it possible to reinforce the structure. They can be filled with materials with change of phase, the objective of which is to simplify the thermal management of the system.

It should be noted that the passages (5) of the cover can be prolonged by passages (5a) on the lateral faces of the cells and join similar passages (similar to the passages (5)) in the bottom of the tank, thus providing an additional reinforcement (see version on the right of FIG. 1). Altogether, the passages thus form a reinforcing jacket.

FIG. 2 illustrates an arrangement of the cells (this time represented with their solid content) allowing the tank a greater flexibility of form. The cells (1a), (1b), (1c), (1d) are offset by an angle (α) (9) which makes it possible to profile the tank according to the curve (10).

The angle α can vary from one cell to another, resulting in different relative orientations of the cells. The inter-cell volumes (4) can be filled with materials with change of phase. They can also be used for the installation of heating and cooling systems. These volumes can also have (a position for) tank structure reinforcing elements.

FIG. 3 shows (in two cross sections along vertical planes at right angles to one another) another possibility of partitioning of the reagents (11), in an injection-molded tank in two or more parts (four cells (1) produced separately in fact). A prepreg material (pre-impregnated composite fibers) can be used to manufacture the tank.

After assembly of the four cells (1) comprising the solid saturated with ammonia (11), the tank is closed in a seal-tight manner with a cover (12) secured by a flange (13). The cover (12) is equipped with an inlet/outlet orifice (7) for the flow of ammonia. The tank comprises a hollow molding (14) inserted between the cells (1) and which serves as a housing for a heating element (15), and which is thus outside the jacket. The tank is reinforced by walls and internal ribs (16) which can be provided with thermally conductive fins. Reinforcing ribs can also be arranged on the outer jacket.

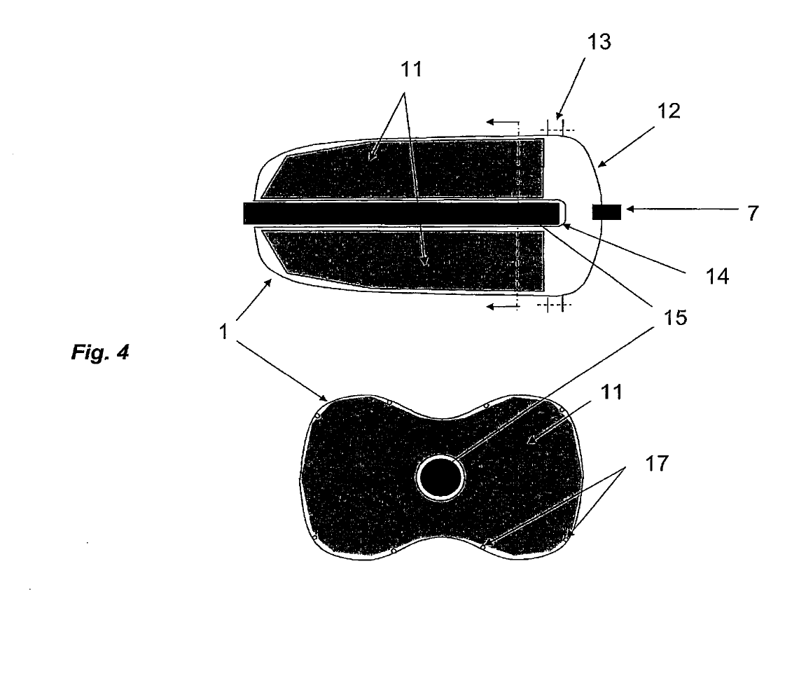

FIG. 4 shows (in two cross sections along vertical planes at right angles to one another) an injection-molded cell (1) comprising a hollow channel (14) making it possible to house a heating element (15). When topping up with ammonia, the heating element (15) can be easily extracted and replaced by a cooling element (in order to favor the adsorption of the ammonia), given that these elements are not fastened in a seal-tight manner on the wall of the cell (1). Thus, the heating element (15) and the cooling element are interchangeable (or removable), in as much as they can be housed removably in the hollow channel (14).

The internal wall of the cell (1) is provided with ribs (17) favoring the passage of the gases between the wall and the reagent (11); this passage also limits the heat losses toward the outside of the cell (1).

The tank can be surrounded by a double wall (not represented) creating a volume that can act as a heat exchanger. This volume can also be filled with a material with change of phase.

1-18. (canceled)

19. A tank for storing ammonia by sorption, the tank comprising:
cells communicating with one another and with at least one orifice communicating with an outside, the cells configured to contain a solid intended for sorption of ammonia,
wherein a form of at least some of the cells and/or their method of production and/or of assembly is such that at least one heating system can be inserted into or between the at least some of the cells.

20. The tank as claimed in claim 19, wherein some cells include one or more channels forming at least one housing making it possible to house the at least one heating system.

21. The tank as claimed in claim 20, wherein the at least one housing is situated between the cells and outside an internal volume thereof.

22. The tank as claimed in claim 20, wherein the at least one heating system is housed removably in the at least one housing.

23. The tank as claimed in claim 19, wherein the form of at least some of the cells and/or their method of production and/or of assembly is such that at least one of the following elements can be inserted into or between the at least some of the cells: a material with change of phase, a cooling element, or a temperature probe.

24. The tank as claimed in claim 19, further comprising a material with change of phase in at least some of the cells and/or between at least some of the cells and/or in a channel insulating at least some of the cells.

25. The tank as claimed in claim 19, wherein an internal wall of the cells includes ribs.

26. The tank as claimed in claim 19, further comprising at least one inlet and one outlet.

27. The tank as claimed in claim 19, wherein the cells comprise a solid intended for the sorption of ammonia, or a chloride of alkali, alkaline earth, or transition metal.

28. The tank as claimed in claim 19, wherein the cells all have a same form.

29. The tank as claimed in claim 19, wherein at least some of the cells are made of a single piece by injection of plastic material.

30. The tank as claimed in claim 19, wherein the cells are produced separately by plastic injection or blow molding, then assembled.

31. The tank as claimed in claim 19, wherein the cells are grouped together under a common cover, delimiting, with their top face, a hollow volume, and wherein each cell comprises at least one orifice communicating with the hollow volume, the cover comprising at least one orifice ensuring communication between the hollow volume and outside of the tank.
